(19) United States
(12) Patent Application Publication
(10) Pub. No.: US 2024/0324590 A1
(43) Pub. Date: Oct. 3, 2024

(54) COMBINATIONS OF TRIAZOLINONE HERBICIDES WITH SAFENERS

(71) Applicants: UPL CORPORATION LIMITED, Port Louis (MU); UPL MAURITIUS LIMITED, Port Louis (MU); UPL EUROPE LTD, Warrington, Cheshire (GB)

(72) Inventors: Giuvan LENZ, Pereiras (BR); Ganesh RAO, E Mumbai (IN); Jean-Phillipe POLLET, Warrington, Cheshire (GB)

(21) Appl. No.: 18/292,515

(22) PCT Filed: Aug. 2, 2022
(86) PCT No.: PCT/GB2022/052029

§ 371 Date: Jan. 26, 2024

(30) Foreign Application Priority Data
Aug. 3, 2021 (EP) 21306085.8

(51) Int. Cl. A01N 25/32; A01N 43/647; A01P 13/02

(52) U.S. Cl. CPC A01N 25/32; A01N 43/647; A01P 13/02

(57) ABSTRACT

The present invention relates to a combination of one or more herbicides and a safener for the selective control of weeds. The present invention provides herbicide combinations comprising sulfonyl amino carbonyl triazolinone herbicides with one or more safeners to effectively control growth of weeds in crops and reducing phytotoxicity in the said crops.

### FIELD OF THE INVENTION

The present invention relates to a combination of one or more herbicides and a safener for the selective control of weeds. More particularly, the present invention relates to a combination of one or more Triazolinone herbicides and one or more safeners for the selective control of weeds, with significant reduction in phytotoxicity.

### BACKGROUND OF THE INVENTION

Herbicides cause phytotoxicity when they are used in a higher dose than recommended, improper application methods, and wrong stage of crop growth. Certain herbicidal compounds can produce phytotoxic vapor during and after spray and thus contaminate sensitive crops and natural vegetation. Other instances of unwanted effects of herbicides on crops are lesser plant height or lesser number of plants standing after herbicidal treatments.

Therefore, the practice being used presently is the application of safeners along with herbicides to protect crop plants from herbicide injury.

Herbicide safeners are chemical agents that reduce the phytotoxicity of herbicides to crop plants without affecting the weed-control efficacy. However, it is pertinent to note that not all safeners have the desired beneficial effect of reduction in phytotoxicity with corresponding herbicides. Therefore, the challenges of identifying suitable herbicide-safener combinations that work efficiently to reduce phytotoxicity in crop plants and control weeds are persistent.

Flucarbazone-sodium is a Group 2 herbicide used for control of grassy and some broadleaf weeds in cereal crops. It belongs to the sulfonyl amino triazolinone class of herbicides. The field half-life of flucarbazone-sodium varies from 6 to 110 days in a range of prairie soils and is known to reduce plant weight. It is likely to persist in soil into the second growing season, particularly under conditions where decomposition is reduced and the phytotoxicity potential is considerably high because of its decreased adsorption in soil.

There is therefore a need in the art for safener combinations with Triazolinone herbicides, such as Flucarbazone that reduce their phytotoxicity, accompanied with a beneficial result in increased plant height and/or increased number of plants standing after herbicidal treatment.

### OBJECTS OF THE INVENTION

The present invention, described hereinafter, achieves at least one of the following objects of the invention.

It is an object of the present invention to provide combinations of at least one triazolinone herbicide with at least one safener.

It is an object of the present invention to provide combinations of at least one sulfonyl amino carbonyl triazolinone herbicide with at least one safener.

It is an object of the present invention to provide combinations of at least one sulfonyl amino carbonyl triazolinone herbicide with one or more safeners of the N-sulfonylcarboxamide group.

It is an object of the present invention to provide combinations of Flucarbazone or salts thereof and Cyprosulfamid.

It is an object of the present invention to provide combinations of triazolinone herbicides with one or more safeners, wherein said combination exhibits negligible or no phytotoxicity, accompanied with an increase in crop height and/or increased number of crops standing after treatment, preferably in corn, wheat, barley, rye, oats, rice, soybean, cotton, canola, sugar beet, potatoes, tobacco, and oil seed rape, more preferably in corn.

It is an object of the present invention to provide a method for controlling weeds using an herbicidal combination comprising a triazolinone herbicide and a safener, more preferably a sulfonyl-amino-carbonyl-triazolinone and a safener, most preferably, Flucarbazone and Cyprosulfamid.

It is an object of the present invention to provide a use of a combination of at least one triazolinone herbicide and a safener to control growth of weeds with reduced or no phytotoxicity in crops accompanied with efficacious growth of crops.

### SUMMARY OF THE INVENTION

In an aspect, the present invention provides herbicide combinations comprising one or more Triazolinone herbicides with one or more safeners.

In an aspect, the present invention provides herbicide combinations comprising one or more triazolinone herbicides with one or more safeners, wherein said triazolinone herbicides are selected from Flucarbazone, Propoxycarbazone, Carfentrazone, Sulfentrazone and Amicarbazone or combinations thereof, wherein said herbicide combination exhibits minimal or no phytotoxicity.

In an aspect, the present invention provides herbicide combinations comprising one or more Triazolinone herbicides with one or more safeners, wherein the Triazolinone herbicides are sulfonyl amino carbonyl triazolinone herbicides.

In an aspect, the present invention provides herbicide combinations comprising sulfonyl amino carbonyl triazolinone herbicides with one or more safeners, wherein said sulfonyl amino carbonyl triazolinone herbicides are preferably selected from Flucarbazone and Propoxycarbazone, the said combinations exhibit minimal or no phytotoxicity.

In an aspect, the present invention provides herbicide combinations comprising sulfonyl amino carbonyl triazolinone herbicides with one or more safeners, wherein said combinations effectively control growth of weeds in cereal crops and reduced phytotoxicity in the said crops.

In an aspect, the present invention provides combinations of sulfonyl amino carbonyl herbicides with one or more safeners, wherein sulfonyl amino carbonyl herbicides are selected from one or more of Flucarbazone and Propoxycarbazone and the said combinations exhibit less or no phytotoxicity, result in increased plant height and/or increased number of plants standing after treatment, preferably in corn, wheat, barley, rye, oats, rice, soybean, cotton, canola, sugar beet, potatoes, tobacco, and oil seed rape, more preferably in corn.

In an aspect, the present invention provides combinations of one or more sulfonyl amino carbonyl triazolinone herbicide with safeners, wherein said safeners are selected from one or more of Cyprosulfamid, Mefenpyr, Mefenpyr-diethyl, Isoxadifen, Isoxadifen-ethyl, Cloquintocet-mexyl, Benoxacor, Flurazole and Fluxofenim.

In an aspect, the present invention provides combinations of sulfonyl amino carbonyl triazolinone with one or more safeners, wherein sulfonyl amino carbonyl triazolinone herbicide are selected from one or more of Flucarbazone and propoxycarbazone and said combinations are applied preferably to corn, wheat, barley, rye, oats, rice, soybean, cotton, canola, sugar beet, potatoes, tobacco, and oil seed rape, more preferably to wheat.

In one aspect, the present invention provides combinations of Flucarbazone and one or more safeners selected from the N-sulfonyl carboxamide group, wherein the N-sulfonyl carboxamide is Cyprosulfamid.

In a further aspect, the present invention provides combinations of Flucarbazone and one or more safeners selected from Mefenpyr, Mefenpyr-diethyl, Isoxadifen, Isoxadifen-ethyl, Cloquintocet-mexyl, Benoxacor, Flurazole and Fluxofenim.

In an embodiment, the safener is Cyprosulfamid.

In a preferred aspect, the present invention provides an herbicide combination of Flucarbazone and Cyprosulfamid, wherein said herbicide combination exhibits minimal or no phytotoxicity.

In an aspect, the present invention provides a method of controlling weeds wherein herbicide combinations comprising sulfonyl amino carbonyl triazolinone herbicides with one or more safeners is applied preferably to seeds, foliage or at a locus of cereal crops, corn, wheat, barley, rye, oats, rice, soybean, cotton, canola, sugar beet, potatoes, tobacco, and oil seed rape, more preferably to corn, wherein said combinations effectively control growth of weeds in cereal crops and reduce phytotoxicity in the said crops.

In an aspect, the present invention provides a method of controlling weeds, wherein an herbicide combination of Flucarbazone and Cyprosulfamid is applied preferably to seeds, foliage or at a locus of cereal crops, corn, wheat, barley, rye, oats, rice, soybean, cotton, canola, sugar beet, potatoes, tobacco, and oil seed rape, more preferably to corn.

In an aspect, the present invention provides a method of reducing phytotoxicity in cereal crops wherein an herbicide combination of Flucarbazone and Cyprosulfamid is applied preferably to cereal crops, corn, wheat, barley, rye, oats, rice, soybean, cotton, canola, sugar beet, potatoes, tobacco, and oil seed rape, more preferably to corn.

### DETAILED DESCRIPTION OF INVENTION

For the purposes of the following detailed description, it is to be understood that the invention may assume various alternative variations, except where expressly specified to the contrary. Moreover, other than in any operating examples, or where otherwise indicated, all numbers expressing, for example, quantities of materials/ingredients used in the specification are to be understood as being modified in all instances by the term “about”. The term “about” used to qualify the amounts of active components shall be interpreted to mean “approximately” or “reasonably close to” and any statistically insignificant variations therefrom.

As used herein, the terms “comprising” “including,” “having,” “containing,” “involving,” and the like are to be understood to be open-ended, i.e., to mean including but not limited to.

In any aspect or embodiment described hereinbelow, the phrase comprising may be replaced by the phrases “consisting of” or “consisting essentially of”. In these aspects or embodiment, the combination or composition described includes or comprises or consists of or consists essentially of or consists substantially of the specific components recited therein, to the exclusion of other ingredients or excipients not specifically recited therein.

The term herbicide, as used herein, shall mean an active ingredient that kills, controls or otherwise adversely modifies the growth of undesired plants.

The term phytotoxicity as used herein refers to adverse effects on plant growth, physiology, or metabolism caused by an herbicide.

As used herein, a herbicidally effective or vegetation controlling amount is an amount of active ingredient that causes a “herbicidal effect,” i.e., an adversely modifying effect and includes deviations from natural development, killing, regulation, desiccation, retardation stunting, dwarfing and the like.

The terms “plants” and “vegetation” include, but are not limited to, germinant seeds, emerging seedlings, plants emerging from vegetative propagules, and established vegetation.

The terms “undesirable vegetation”, “harmful plants”, “unwanted plants”, “weeds” and “weed species”, as used herein, are synonyms.

The term “locus” as used herein shall denote the vicinity of a desired crop in which weed control, typically selective weed control is desired. The locus includes the vicinity of desired crop plants wherein the weed infestation has either emerged or is yet to emerge.

The term “crop” shall include a multitude of desired crop plants or an individual crop plant growing at a locus.

References to the term g ai/ha or g A/ha refer to grams of active ingredient per hectare of area.

Each of the aspects described above may have one or more embodiments.

Each of the embodiments described hereinafter may apply to one or all of the aspects described hereinabove. These embodiments are intended to be read as being preferred features of one or all of the aspects described hereinabove. Each of the embodiments described hereinafter applies to each of the aspects described hereinabove individually.

It has surprisingly been found by the present inventors that a combination of one or more triazolinone herbicides with one or more safeners selectively controls the growth of weeds and reduces phytotoxicity in crop plants. Treatments with one or more triazolinone herbicides alone resulted in massive phytotoxicity over a period of one month post application, characterized by lesser plant height and lesser number of plants standing after treatments. Contrastingly, treatments involving Triazolinone herbicides with one or more safeners resulted in reduced phytotoxicity and effective control of weeds over a period of one month.

In an embodiment, the herbicide is flucarbazone.

In an embodiment, the safener is cyprosulfamid.

More specifically, it is known that some corn hybrids are sensitive to herbicides, particularly sweet corn. The herbicide-induced injury ranges from temporary symptoms, such as stunting or leaf damage, to permanent damage including yield loss, and in severe cases, crop death. The present inventors have exerted tremendous inventive ingenuity by providing a combination of one or more triazolinone herbicides, preferably flucarbazone with one or more safeners, preferably Cyprosulfamid, which have proven to selectively control the growth of weeds and considerably reduce phytotoxicity in cereal crop plants, preferably corn, during an extended time interval of over six months, more preferably over three months, most preferably over one month after application.

In an embodiment, the present invention provides herbicide combinations comprising one or more Triazolinone herbicides and one or more safeners.

In another embodiment, the present invention provides herbicide combinations comprising one or more triazolinone herbicides and one or more safeners, wherein said triazolinone herbicides are selected from Flucarbazone, Propoxycarbazone, Carfentrazone, Sulfentrazone and Amicarbazone or combinations thereof, wherein said herbicide combinations exhibit minimal or no phytotoxicity.

In another embodiment, the present invention provides herbicide combinations comprising triazolinone herbicides and one or more safeners, wherein said triazolinone herbicides are selected from Flucarbazone, Propoxycarbazone, Carfentrazone, Sulfentrazone and Amicarbazone or combinations thereof, wherein said herbicide combinations exhibit minimal or no phytotoxicity.

In another embodiment, the present invention provides herbicide combinations comprising triazolinone herbicides and one or more safeners, wherein said triazolinone herbicides are selected from Flucarbazone, Propoxycarbazone, Carfentrazone, Sulfentrazone and Amicarbazone or combinations thereof, wherein said herbicide combinations exhibit minimal or no phytotoxicity during an extended time interval of over six months, more preferably over three months, most preferably over one month after application of the said combination.

In another embodiment, the present invention provides herbicide combinations comprising triazolinone herbicides and one or more safeners, wherein said triazolinone herbicides are selected from Flucarbazone, Propoxycarbazone, Carfentrazone, Sulfentrazone and Amicarbazone or combinations thereof, wherein said herbicide combinations exhibit effective control of weeds.

Accordingly, the present invention provides herbicide combinations comprising a triazolinone herbicide and a safener, wherein the ratio of the triazolinone herbicide to the safener is from 100:1 to 1:1 or 90:1 to 1:1, or 75:1 to 1:1 or 50:1 to 1:1 or 25:1 to 1.1 or 10:1 to 1:1 or 5:1 to 1:1 or 2:1 to 1:1, more preferably from 25:1 to 1.1 or 10:1 to 1:1 or 5:1 to 1:1 or 3:1 to 1:1 or 2:1 to 1.1, most preferably from 2:1 to 1:1.

In yet another embodiment, the present invention provides herbicide combinations comprising triazolinone herbicides and one or more safeners, wherein said triazolinone herbicides are selected from Flucarbazone, Propoxycarbazone, Carfentrazone, Sulfentrazone and Amicarbazone or combinations thereof and the said combinations exhibit less or no phytotoxicity, result in increased plant height and/or increased number of plants standing after treatment, preferably in corn, wheat, barley, rye, oats, rice, soybean, cotton, canola, sugar beet, potatoes, tobacco, and oil seed rape, more preferably in corn.

In an embodiment, the present invention provides combinations of triazolinone herbicides and one or more safeners selected from Cyprosulfamid, Mefenpyr, Mefenpyr-diethyl, Isoxadifen, Isoxadifen-ethyl, Cloquintocet-mexyl, Benoxacor, Flurazole and Fluxofenim, preferably Cyprosulfamid.

In one preferred embodiment, the present invention provides herbicide combinations comprising one or more sulfonyl amino carbonyl triazolinone herbicides and one or more safeners, wherein the sulfonyl amino carbonyl triazolinone herbicides are selected from Flucarbazon and/or propoxycarbazone or salts thereof.

In one preferred embodiment, the present invention provides combinations comprising one or more sulfonyl amino carbonyl triazolinone herbicide and one or more safeners wherein the sulfonyl amino carbonyl triazolinone herbicide is selected from Flucarbazone and/or propoxycarbazone.

In one embodiment, the present invention provides combinations comprising one or more sulfonyl amino carbonyl triazolinone herbicides and one or more safeners wherein said sulfonyl amino carbonyl triazolinone herbicide is selected from Flucarbazone and/or propoxycarbazone, wherein said herbicide combinations exhibit minimal or no phytotoxicity.

In another embodiment, the present invention provides herbicide combinations comprising one or more sulfonyl amino carbonyl triazolinone herbicides and one or more safeners, wherein said sulfonyl amino carbonyl triazolinone herbicide is selected from Flucarbazone and/or Propoxycarbazone, wherein said herbicide combinations exhibit minimal or no phytotoxicity during an extended time interval of over six months, more preferably over three months, most preferably over one month after application of the said combination.

In another embodiment, the present invention provides herbicide combinations comprising one or more sulfonyl amino carbonyl triazolinone herbicides and one or more safeners, wherein said sulfonyl amino carbonyl triazolinone herbicide is selected from Flucarbazone and Propoxycarbazone, wherein said herbicide combinations exhibits effective control of weeds.

In one embodiment, the present invention provides herbicide combinations comprising one or more of sulfonyl amino carbonyl triazolinone herbicides and one or more safeners, wherein the ratio of the sulfonyl amino carbonyl triazolinone herbicide to safener is from 100:1 to 1:1 or 90:1 to 1:1, or 75:1 to 1:1 or 50:1 to 1:1 or 25:1 to 1.1 or 10:1 to 1:1 or 5:1 to 1:1 or 3:1 to 1:1, 2:1 to 1:1, more preferably from 25:1 to 1.1 or 10:1 to 1:1 or 5:1 to 1:1 or 3:1 to 1:1 or 2:1 to 1.1, most preferably from 2:1 to 1:1.

In yet another embodiment, the present invention provides herbicide combinations comprising sulfonyl amino carbonyl triazolinone herbicides and one or more safeners, wherein said sulfonyl amino carbonyl triazolinone herbicides are selected from Flucarbazone, and Propoxycarbazone, and the said combinations exhibit reduced or no phytotoxicity, result in increased plant height and/or increased number of plants standing after treatment, preferably in cereal crops, corn, wheat, barley, rye, oats, rice, soybean, cotton, canola, sugar beet, potatoes, tobacco, and oil seed rape, more preferably in corn.

In an embodiment, the present invention provides combinations comprising one or more of sulfonyl amino carbonyl triazolinone herbicides and one or more safeners selected from Cyprosulfamid, Mefenpyr, Mefenpyr-diethyl, Isoxadifen, Isoxadifen-ethyl, Cloquintocet-mexyl, Benoxacor, Flurazole and Fluxofenim, preferably Cyprosulfamid.

In an embodiment, the safener is cyprosulfamid.

In a further embodiment, the present invention provides herbicide combinations of Flucarbazone and one or more safeners selected from Cyprosulfamid, Mefenpyr, Mefenpyr-diethyl, Isoxadifen, Isoxadifen-ethyl, Cloquintocet-mexyl, Benoxacor, Flurazole and Fluxofenim, preferably Cyprosulfamid.

In an embodiment, the present invention provides herbicide combinations of Flucarbazone and one or more safeners selected from the N-sulfonyl carboxamide group, wherein the N-sulfonyl carboxamide is Cyprosulfamid.

In one preferred embodiment, the present invention provides herbicide combinations comprising a sulfonyl amino carbonyl triazolinone herbicide and a safener, wherein the sulfonyl amino carbonyl triazolinone herbicide is Flucarbazone and the safener is Cyprosulfamid.

In one preferred embodiment, the present invention provides herbicide combinations comprising a sulfonyl amino carbonyl triazolinone herbicide and a safener, wherein the sulfonyl amino carbonyl triazolinone herbicide is Flucarbazone and the safener is Cyprosulfamid, wherein said herbicide combination exhibits minimal or no phytotoxicity.

In one embodiment, the present invention provides herbicide combinations comprising a sulfonyl amino carbonyl triazolinone herbicide and a safener, wherein sulfonyl amino carbonyl triazolinone herbicide is Flucarbazone and the safener is Cyprosulfamid, wherein the ratio of Flucarbazone to Cyprosulfamid is from 100:1 to 1:1 or 90:1 to 1:1, or 75:1 to 1:1 or 50:1 to 1:1 or 25:1 to 1.1 or 10:1 to 1:1 or 5:1 to 1:1 or 3:1 to 1:1 or 2:1 to 1:1, more preferably from 25:1 to 1.1 or 10:1 to 1:1 or 5:1 to 1:1 or 3:1 to 1:1 or 2:1 to 1.1, most preferably from 3:1 to 1:1.

In one preferred embodiment, the present invention provides herbicide combinations comprising a sulfonyl amino carbonyl triazolinone herbicide and a safener wherein, sulfonyl amino carbonyl triazolinone herbicide is Flucarbazone and the safener is Cyprosulfamid, wherein the ratio of Flucarbazone to Cyprosulfamid is 5:1 or 3:1, 2:1 or 1.75:1, or 1.5:1 or 1:1, more preferably 1.75:1, or 1.5:1 or 1:1, most preferably 1.75:1.

In one preferred embodiment, the present invention provides herbicide combinations comprising a sulfonyl amino carbonyl triazolinone herbicide and a safener, wherein sulfonyl amino carbonyl triazolinone herbicide is Flucarbazone and the safener is Cyprosulfamid, wherein the ratio of Flucarbazone to Cyprosulfamid is 2:1 or 1.75:1, or 1.5:1 or 1:1, more preferably 1.75:1, or 1.5:1 or 1:1, most preferably 1.75:1, wherein, the said combinations exhibit reduced or no phytotoxicity, result in increased plant height and/or increased number of plants standing after treatment, preferably in cereal crops, corn, wheat, barley, rye, oats, rice, soybean, cotton, canola, sugar beet, potatoes, tobacco, and oil seed rape, more preferably in corn.

In an embodiment, the present invention provides herbicide combinations of Flucarbazone and Isoxadifen.

In an embodiment, the present invention provides herbicide combinations of Flucarbazone and Isoxadifen ethyl.

In an embodiment, the present invention provides herbicide combinations of Flucarbazone and Mefenpyr.

In an embodiment, the present invention provides herbicide combinations of Flucarbazone and Mefenpyr-diethyl.

In an embodiment, the present invention provides herbicide combinations of Flucarbazone and Cloquintocet.

In an embodiment, the present invention provides herbicide combinations of Flucarbazone and Benoxacor.

In an embodiment, the present invention provides herbicide combinations of Flucarbazone and Flurazole.

In an embodiment, the present invention provides herbicide combinations of Flucarbazone and Fluxofenim.

In an embodiment, the present invention provides combinations of Propoxycarbazone and one or more safeners selected from the N-sulfonyl carboxamide group, wherein the N-sulfonyl carboxamide is Cyprosulfamid.

In a further embodiment, the present invention provides combinations of Propoxycarbazone and one or more safeners selected from Cyprosulfamid, Mefenpyr, Mefenpyr-diethyl, Isoxadifen, Isoxadifen-ethyl, Cloquintocet-mexyl, Benoxacor, Flurazole and Fluxofenim, preferably Cyprosulfamid.

In one preferred embodiment, the present invention provides herbicide combinations comprising a sulfonyl amino carbonyl triazolinone herbicide and a safener wherein the sulfonyl amino carbonyl triazolinone herbicide is Propoxycarbazone and the safener is Cyprosulfamid.

In one preferred embodiment, the present invention provides herbicide combinations comprising a sulfonyl amino carbonyl triazolinone herbicide and a safener wherein the sulfonyl amino carbonyl triazolinone herbicide is Propoxycarbazone and the safener is Cyprosulfamid, wherein said herbicide combinations exhibits minimal or no phytotoxicity.

In one embodiment, the present invention provides herbicide combinations comprising a sulfonyl amino carbonyl triazolinone herbicide and a safener wherein the sulfonyl amino carbonyl triazolinone herbicide is Propoxycarbazone and the safener is Cyprosulfamid, wherein the ratio of Propoxycarbazone to Cyprosulfamid is from 100:1 to 1:1 or 90:1 to 1:1, or 75:1 to 1:1 or 50:1 to 1:1 or 25:1 to 1.1 or 10:1 to 1:1 or 5:1 to 1:1 or 2:1 to 1:1, more preferably from 25:1 to 1.1 or 10:1 to 1:1 or 5:1 to 1:1 or 2:1 to 1.1, most preferably from 2:1 to 1:1.

In one preferred embodiment, the present invention provides herbicide combinations comprising a sulfonyl amino carbonyl triazolinone herbicide and a safener wherein the sulfonyl amino carbonyl triazolinone herbicide is Propoxycarbazone and the safener is Cyprosulfamid, wherein the ratio of Propoxycarbazone to Cyprosulfamid is 2:1 or 1.75:1, or 1.5:1 or 1:1, more preferably 1.75:1, or 1.5:1 or 1:1, most preferably 1.75:1.

In one preferred embodiment, the present invention provides herbicide combinations comprising a sulfonyl amino carbonyl triazolinone herbicide and a safener wherein the sulfonyl amino carbonyl triazolinone herbicide is Propoxycarbazone and the safener is Cyprosulfamid, wherein the ratio of Propoxycarbazone to Cyprosulfamid is 2:1 or 1.75:1, or 1.5:1 or 1:1, more preferably 1.75:1, or 1.5:1 or 1:1, most preferably 1.75:1, wherein, the said combinations exhibit reduced or no phytotoxicity, result in increased plant height and/or increased number of plants standing after treatment, preferably in cereal crops, corn, wheat, barley, rye, oats, rice, soybean, cotton, canola, sugar beet, potatoes, tobacco, and oil seed rape, more preferably in corn.

In an embodiment, the present invention provides herbicide combination of Propoxycarbazone and Isoxadifen.

In an embodiment, the present invention provides herbicide combination of Propoxycarbazone and Isoxadifen ethyl.

In an embodiment, the present invention provides herbicide combination of Propoxycarbazone and Mefenpyr.

In an embodiment, the present invention provides herbicide combination of Propoxycarbazone and Mefenpyr-diethyl.

In an embodiment, the present invention provides herbicide combination of Propoxycarbazone and Cloquintocet.

In an embodiment, the present invention provides herbicide combination of Propoxycarbazone and Benoxacor.

In an embodiment, the present invention provides herbicide combination of Propoxycarbazone and Flurazole.

In an embodiment, the present invention provides herbicide combination of Propoxycarbazone and Fluxofenim.

In still another embodiment, the herbicide safener combination is formulated together and applied in pre-emergence application or post-emergence application.

In still another embodiment, the components are formulated separately and applied sequentially or as a tank mix.

In still another embodiment, the components are formulated separately and applied sequentially or as a tank mix, wherein safeners are applied to seeds from which crops are grown and herbicides are later applied to the soil or grown crops.

In still another embodiment, the safener is applied to the seeds or other propagation material of the crops prior to sowing or to the soil shortly after sowing in an in furrow-treatment.

In another embodiment, the present invention provides a combination of one or more sulfonyl amino carbonyl triazolinone herbicide and one or more safeners selected from Cyprosulfamid, Mefenpyr, Mefenpyr-diethyl, Isoxadifen, Isoxadifen-ethyl, Cloquintocet-mexyl, Benoxacor, Flurazole and Fluxofenim, preferably Cyprosulfamid, wherein said combination is formulated together and applied in pre-emergence application or post-emergence application to preferably to cereal crops, corn, wheat, barley, rye, oats, rice, soybean, cotton, canola.

In another embodiment, the present invention provides a combination of one or more sulfonyl amino carbonyl triazolinone herbicide selected from Flucarbazone and Propoxycarbazone and safeners selected from N-sulfonyl carboxamide, said safener is Cyprosulfamid, wherein said combination is formulated together and applied in pre-emergence application or post-emergence application to preferably to cereal crops, corn, wheat, barley, rye, oats, rice, soybean, cotton, canola.

In another embodiment, the present invention provides a combination of one or more sulfonyl amino carbonyl triazolinone herbicide selected from Flucarbazone and Propoxycarbazone and safeners selected from N-sulfonyl carboxamide, said safener is Cyprosulfamid, wherein said combination is formulated together and applied in pre-emergence application or post-emergence application to preferably to cereal crops, corn, wheat, barley, rye, oats, rice, soybean, cotton, canola, sugar beet, potatoes, tobacco, and oil seed rape, more preferably to corn.

In one preferred embodiment, the present invention provides a combination of Flucarbazone and Cyprosulfamid, wherein said combination is formulated together and applied in pre-emergence application or post-emergence application to preferably to cereal crops, corn, wheat, barley, rye, oats, rice, soybean, cotton, canola, sugar beet, potatoes, tobacco, and oil seed rape, more preferably to corn.

In one more preferred embodiment, the present invention provides a combination of Propoxycarbazone and Cyprosulfamid, wherein said combination is formulated together and applied in pre-emergence application or post-emergence application to preferably to cereal crops, corn, wheat, barley, rye, oats, rice, soybean, cotton, canola, sugar beet, potatoes, tobacco, and oil seed rape, more preferably to corn.

In another embodiment, the present invention provides a combination of one or more sulfonyl amino carbonyl triazolinone herbicide and one or more safeners selected from Cyprosulfamid, Mefenpyr, Mefenpyr-diethyl, Isoxadifen, Isoxadifen-ethyl, Cloquintocet-mexyl, Benoxacor, Flurazole and Fluxofenim, preferably Cyprosulfamid, wherein said combination is formulated separately and applied sequentially or as a tank mix, preferably to cereal crops, corn, wheat, barley, rye, oats, rice, soybean, cotton, canola, sugar beet, potatoes, tobacco, and oil seed rape, more preferably to corn.

In yet another embodiment, the present invention provides a combination of one or more sulfonyl amino carbonyl triazolinone herbicide is selected from Flucarbazone and propoxycarbazone and safeners selected from N-sulfonyl carboxamide, said safener is Cyprosulfamid, wherein the herbicide safener combination is formulated separately and applied sequentially or as a tank mix, preferably to cereal crops, corn, wheat, barley, rye, oats, rice, soybean, cotton, canola, sugar beet, potatoes, tobacco, and oil seed rape, more preferably to corn.

In one more preferred embodiment, the present invention provides a combination of Flucarbazone and Cyprosulfamid, wherein the herbicide safener combination is formulated separately and applied sequentially or as a tank mix preferably to cereal crops, corn, wheat, barley, rye, oats, rice, soybean, cotton, canola, sugar beet, potatoes, tobacco, and oil seed rape, more preferably to corn.

In one more preferred embodiment, the present invention provides a combination of Flucarbazone and Cyprosulfamid, wherein the herbicide safener combination is applied sequentially or as a tank mix preferably to the corn crop.

In one more preferred embodiment, the safener selected from N-sulfonyl carboxamide, the said safener being Cyprosulfamid is applied to the seeds or other propagation material of the crops prior to sowing or to the soil shortly after sowing in an in furrow-treatment.

In one embodiment, the present invention provides a combination of one or more sulfonyl amino carbonyl triazolinone herbicide is selected from Flucarbazone and propoxycarbazone and safeners selected from N-sulfonyl carboxamide, said safener is Cyprosulfamid for the control of weeds selected from the group comprising Amaranthus spp., Amaranthus viridis, Cenchrus echinatus, broadleaf signalgrass (Brachiaria platvphvlla), large crabgrass (Digitaria sanguinalis), barnyard grass (Echinochloa crusgaili), rigid ryegrass (Lolium rigidum), fall panicum (Panicum dichotomiflorum), giant foxtail (Setaria faberi), green foxtail (Setaria viridis), Johnsongrass (Sor hum halepense), velvetleaf (Abutilon theophrasti), redroot pigweed (Amaranthus retroflexus), common lambsquarters (Chenopodium album), Ivyleaf morning glory (Ipomoea hederacea), common purslane {Portulaca oleracea), and common cockleburr (Xanthium strumarium).

In another embodiment, the present invention provides a combination of one or more sulfonyl amino carbonyl triazolinone herbicide and one or more safeners selected from Cyprosulfamid, Mefenpyr, Mefenpyr-diethyl, Isoxadifen, Isoxadifen-ethyl, Cloquintocet-mexyl, Benoxacor, Flurazole and Fluxofenim, preferably Cyprosulfamid, wherein said combination is formulated together and applied in pre-emergence application or post-emergence application to seeds, foliage or at the locus of preferably cereal crops, corn, wheat, barley, rye, oats, rice, soybean, cotton, canola, sugar beet, potatoes, tobacco, and oil seed rape, more preferably to corn, wherein ratio of the herbicide and said safener is from 25:1 to 1:1, more preferably from 10:1 to 1:1, most preferably from 5:1 to 1:1.

In still another embodiment, the combination of Flucarbazone and Cyprosulfamid is formulated together and applied in pre-emergence application or post-emergence application to seeds, foliage or at the locus of preferably cereal crops, corn, wheat, barley, rye, oats, rice, soybean, cotton, canola, sugar beet, potatoes, tobacco, and oil seed rape, more preferably to corn, wherein ratio of Flucarbazone and Cyprosulfamid is from 25:1 to 1:1.

In one preferred embodiment, the combination of Flucarbazone and Cyprosulfamid is formulated together and applied in pre-emergence application or post-emergence application to seeds, foliage or at the locus of preferably cereal crops, corn, wheat, barley, rye, oats, rice, soybean, cotton, canola, sugar beet, potatoes, tobacco, and oil seed rape, more preferably to corn, wherein ratio of Flucarbazone and Cyprosulfamid is from 10:1 to 1:1.

In one more preferred embodiment, the combination of Flucarbazone and Cyprosulfamid is formulated together and applied in pre-emergence application or post-emergence application to seeds, foliage or at the locus of preferably cereal crops, corn, wheat, barley, rye, oats, rice, soybean, cotton, canola, sugar beet, potatoes, tobacco, and oil seed rape, more preferably to corn, wherein ratio of Flucarbazone and Cyprosulfamid is from 5:1 to 1:1.

In one more preferred embodiment, the combination of Flucarbazone and Cyprosulfamid is formulated together and applied in pre-emergence application or post-emergence application to seeds, foliage or at the locus of preferably cereal crops, corn, wheat, barley, rye, oats, rice, soybean, cotton, canola, sugar beet, potatoes, tobacco, and oil seed rape, more preferably to corn, wherein ratio of Flucarbazone and Cyprosulfamid is from 3:1 to 1:1.

In one further embodiment, the combination of Propoxycarbazone and Cyprosulfamid is formulated together and applied in pre-emergence application or post-emergence application to seeds, foliage or at the locus of preferably cereal crops, corn, wheat, barley, rye, oats, rice, soybean, cotton, canola, sugar beet, potatoes, tobacco, and oil seed rape, more preferably to corn, wherein ratio of Propoxycarbazone and Cyprosulfamid is from 25:1 to 1:1.

In one embodiment, the combination of Propoxycarbazone and Cyprosulfamid is formulated together and applied in pre-emergence application or post-emergence application to seeds, foliage or at the locus of preferably cereal crops, corn, wheat, barley, rye, oats, rice, soybean, cotton, canola, sugar beet, potatoes, tobacco, and oil seed rape, more preferably to corn, wherein ratio of Propoxycarbazone and Cyprosulfamid is from 10:1 to 1:1.

In one more embodiment, the combination of Propoxycarbazone and Cyprosulfamid is formulated together and applied in pre-emergence application or post-emergence application to seeds, foliage or at the locus of preferably cereal crops, corn, wheat, barley, rye, oats, rice, soybean, cotton, canola, sugar beet, potatoes, tobacco, and oil seed rape, more preferably to corn, wherein ratio of Propoxycarbazone and Cyprosulfamid is from 5:1 to 1:1.

In another embodiment, the combination of one or more sulfonyl amino carbonyl triazolinone herbicides and one or more safeners selected from Cyprosulfamid, Mefenpyr, Mefenpyr-diethyl, Isoxadifen, Isoxadifen-ethyl, Cloquintocet-mexyl, Benoxacor, Flurazole and Fluxofenim is formulated together and applied in pre-emergence application or in post-emergence application to foliage or at the locus of preferably corn, wheat, barley, rye, oats, rice, soybean, cotton, canola, sugar beet, potatoes, tobacco, and oil seed rape, wherein the herbicide is applied at the rate from 20 to 100 g ai/ha and the safener is applied at a rate ranging from 50 to 250 g ai/ha, preferably at 50 or 200 g ai/ha.

In another embodiment, the combination of one or more sulfonyl amino carbonyl triazolinone herbicides and one or more safeners selected from Cyprosulfamid, Mefenpyr, Mefenpyr-diethyl, Isoxadifen, Isoxadifen-ethyl, Cloquintocet-mexyl, Benoxacor, Flurazole and Fluxofenim is formulated together and applied in pre-emergence application or in post-emergence application to foliage or at the locus of preferably corn, wheat, barley, rye, oats, rice, soybean, cotton, canola, sugar beet, potatoes, tobacco, and oil seed rape, wherein the herbicide is applied at the rate from 20 to 100 g ai/ha or 20 to 40 g ai/ha and the safener is applied at a rate ranging from 50 to 70 g ai/ha, preferably at 60 or 70 g ai/ha.

In a preferred embodiment, the combination of Flucarbazone and Cyprosulfamid is formulated together and applied in pre-emergence application or post-emergence application to foliage or at the locus of the crop, wherein Flucarbazone is applied at the rate from 20 to 100 g ai/ha, preferably from 20 to 40 g ai/ha, and Cyprosulfamid is applied at the rate ranging from 50 to 250 g ai/ha, preferably at 50 or 200 g ai/ha.

In an embodiment, the combination of Flucarbazone and Cyprosulfamid is formulated together and applied in pre-emergence application or post-emergence application to foliage or at the locus of preferably corn, wheat, barley, rye, oats, rice, soybean, cotton, canola, sugar beet, potatoes, tobacco, and oil seed rape, wherein Flucarbazone is applied at the rate from 20 to 40 g ai/ha and Cyprosulfamid applied at the rate ranging from 50 to 70 g ai/ha, preferably at 60 or 70 g ai/ha.

In one preferred embodiment, the combination of Flucarbazone and Cyprosulfamid is formulated together and applied in pre-emergence application or post-emergence application to foliage or at the locus of preferably corn, wheat, barley, rye, oats, rice, soybean, cotton, canola, sugar beet, potatoes, tobacco, and oil seed rape, wherein Flucarbazone is applied at the rate of 30 g ai/ha and Cyprosulfamid applied at the rate of 66 g ai/ha.

In one preferred embodiment, the combination of Flucarbazone and Cyprosulfamid is formulated together and applied in pre-emergence application or post-emergence application to foliage or at the locus of preferably corn, wheat, barley, rye, oats, rice, soybean, cotton, canola, sugar beet, potatoes, tobacco, and oil seed rape, wherein Flucarbazone is applied at the rate of 45 g ai/ha and Cyprosulfamid is applied at the rate of 90 g ai/ha.

In one preferred embodiment, the combination of Flucarbazone and Cyprosulfamid is formulated together and applied in pre-emergence application or post-emergence application to foliage or at the locus of preferably corn, wheat, barley, rye, oats, rice, soybean, cotton, canola, sugar beet, potatoes, tobacco, and oil seed rape, wherein Flucarbazone is applied at the rate of 45 g ai/ha and Cyprosulfamid is applied at the rate of 148.5 g ai/ha.

In one more preferred embodiment, the combination of Flucarbazone and Cyprosulfamid is formulated together and applied in pre-emergence application or post-emergence application to preferably to foliage or at the locus of corn crop plants, wherein Flucarbazone is applied at the rate of 30 g ai/ha and Cyprosulfamid applied at the rate of 66 g ai/ha.

In one more preferred embodiment, the combination of Flucarbazone and Cyprosulfamid is formulated together and applied in pre-emergence application or post-emergence application to preferably to foliage or at the locus of corn crop plants, wherein Flucarbazone is applied at the rate of 45 g ai/ha and Cyprosulfamid applied at the rate of 90 g ai/ha.

In one more preferred embodiment, the combination of Flucarbazone and Cyprosulfamid is formulated together and applied in pre-emergence application or post-emergence application to preferably to foliage or at the locus of corn crop plants, wherein Flucarbazone is applied at the rate of 45 g ai/ha and Cyprosulfamid applied at the rate of 148.5 g ai/ha.

In another embodiment, one or more safeners selected from Cyprosulfamid, Mefenpyr, Mefenpyr-diethyl, Isoxadifen, Isoxadifen-ethyl, Cloquintocet-mexyl, Benoxacor, Flurazole and Fluxofenim is applied to seeds of corn, wheat, barley, rye, oats, rice, soybean, cotton, canola, sugar beet, potatoes, tobacco, and oil seed rape, more preferably to seeds of corn, and triazolinone herbicide is applied later to the soil or grown crops, wherein the triazolinone herbicide is applied at the rate from 20 to 40 g ai/ha and the safener is applied at the rate ranging from 0.1 to 10 g. ai/Kg seed, preferably at 0.1 to 5 g. ai/Kg seed

In still another embodiment, Cyprosulfamid is applied to seeds of corn, wheat, barley, rye, oats, rice, soybean, cotton, canola, sugar beet, potatoes, tobacco, and oil seed rape, more preferably to seeds of corn, and Flucarbazone is applied later to the soil or grown crops, wherein Flucarbazone is applied at the rate from 20 to 40 g ai/ha and Cyprosulfamid applied at the rate ranging from 0.1 to 10 g·ai/Kg seed, preferably at 0.1 to 5 g·ai/Kg seed

In still another embodiment, Cyprosulfamid is applied to seeds of corn, wheat, barley, rye, oats, rice, soybean, cotton, canola, sugar beet, potatoes, tobacco, and oil seed rape, more preferably to seeds of corn, and Flucarbazone is applied later to the soil or grown crops, wherein Flucarbazone is applied at the rate of 30 g ai/ha and Cyprosulfamid applied at the rate of 0.2 g. ai/Kg seed

In yet another preferred embodiment, Cyprosulfamid is applied to seeds of corn, wheat, barley, rye, oats, rice, soybean, cotton, canola, sugar beet, potatoes, tobacco, and oil seed rape, more preferably to seeds of corn, and Flucarbazone is applied later to the soil or grown crops, wherein Flucarbazone is applied at the rate of 30 g ai/ha and Cyprosulfamid is applied at the rate of 66 g ai/ha.

In still another embodiment, the combination of Propoxycarbazone and Cyprosulfamid is formulated together and applied in pre-emergence application or post-emergence application to preferably to corn, wheat, barley, rye, oats, rice, soybean, cotton, canola, sugar beet, potatoes, tobacco, and oil seed rape, more preferably to wheat, wherein Propoxycarbazone is applied at the rate from 20 to 40 g ai/ha and Cyprosulfamid applied at the rate ranging from 50 to 70 g ai/ha, preferably at 60 or 70 g ai/ha.

In one preferred embodiment, the combination of Propoxycarbazone and Cyprosulfamid is formulated together and applied in pre-emergence application or post-emergence application to preferably to corn, wheat, barley, rye, oats, rice, soybean, cotton, canola, sugar beet, potatoes, tobacco, and oil seed rape, more preferably to wheat, wherein Propoxycarbazone is applied at the rate of 30 g ai/ha and Cyprosulfamid applied at the rate of 66 g ai/ha.

In one more preferred embodiment, the combination of Propoxycarbazone and Cyprosulfamid is formulated together and applied in pre-emergence application or post-emergence application to preferably to corn, wherein Propoxycarbazone is applied at the rate of 30 g ai/ha and Cyprosulfamid applied at the rate of 66 g ai/ha.

In still another embodiment, Cyprosulfamid is applied to seeds of corn, wheat, barley, rye, oats, rice, soybean, cotton, canola, sugar beet, potatoes, tobacco, and oil seed rape, more preferably to seeds of corn, and Propoxycarbazone is applied later to the soil or grown crops, wherein Propoxycarbazone is applied at the rate from 20 to 40 g ai/ha and Cyprosulfamid applied at the rate ranging from 0.1 to 10 g. ai/Kg seed, preferably at 0.1 to 5 g. ai/Kg seed.

In still another embodiment, Cyprosulfamid is applied to seeds of corn, wheat, barley, rye, oats, rice, soybean, cotton, canola, sugar beet, potatoes, tobacco, and oil seed rape, more preferably to seeds of corn, and Propoxycarbazone is applied later to the soil or grown crops, wherein Propoxycarbazone is applied at the rate of 30 g ai/ha and Cyprosulfamid applied at the rate of 0.2 g·ai/Kg seed.

In yet another preferred embodiment, Cyprosulfamid is applied to seeds of corn, wheat, barley, rye, oats, rice, soybean, cotton, canola, sugar beet, potatoes, tobacco, and oil seed rape, more preferably to seeds of corn, and Propoxycarbazone is applied later to the soil or grown crops, wherein Propoxycarbazone is applied at the rate of 30 g ai/ha and Cyprosulfamid is applied at the rate of 0.2 g·ai/Kg seed.

In an embodiment, the present invention provides preferred combinations, compositions and methods thereof. The methods of the invention include a method of controlling weeds at a locus by applying to the locus the combination or the composition, and a method of reducing phytotoxicity in a crop by application of the combination or composition, and a method of increasing yield in a crop by application of the combination or composition, or a method of improving the plant health by application at the locus of the plant the combination or the composition.

Thus, in an embodiment, the present invention provides an herbicide composition comprising one or more triazolinone herbicides and one or more safeners, wherein said triazolinone herbicides are selected from Flucarbazone, Propoxycarbazone, Carfentrazone, Sulfentrazone and Amicarbazone or combinations thereof, wherein said herbicide combinations exhibit minimal or no phytotoxicity.

In a further embodiment, the present invention provides an herbicide composition comprising one or more sulfonyl amino carbonyl triazolinone herbicides and one or more safeners, wherein the sulfonyl amino carbonyl triazolinone herbicides are selected from Flucarbazone and/or Propoxycarbazone.

Accordingly, the safener is preferably selected from the N-sulfonyl carboxamide group, wherein the N-sulfonyl carboxamide is Cyprosulfamid.

In a preferred embodiment, the present invention provides an herbicide composition comprising Flucarbazone and Cyprosulfamid.

In an embodiment, the present invention provides an herbicide composition comprising Propoxycarbazone and Cyprosulfamid.

In a further embodiment, the safeners may also be selected from Mefenpyr, Mefenpyr-diethyl, Isoxadifen, Isoxadifen-ethyl, Cloquintocet-mexyl, Benoxacor, Flurazole and Fluxofenim, preferably Cyprosulfamid.

The compositions may further comprise at least one agrochemically acceptable excipient.

The dosage level of the individual herbicides may be defined by the inherent efficacy of the compound, the pest pressure, soil type, the weather, the formulation type and many other indeterminate variables. These standard dosage levels are fixed by the regulatory authorities.

The herbicidal compositions of the present disclosure can be in any conventional agriculturally useful form, for example, in the form of a ready-to-use formulation, or in the form of a tank mix.

In an embodiment, the herbicidal compositions of the present disclosure are tank mixes.

The herbicidal combinations of the present invention may be used to target weeds among the crops such as corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., vines, kaki fruit, olive, plum, banana, oil palm, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In an embodiment, the composition of the present invention may contain agriculturally acceptable adjuvants, carriers, diluents, emulsifiers, fillers, anti-foaming agents, thickening agents, anti-freezing agents, freezing agents etc. The compositions may be either solid or liquids. They can be solids, such as, for example, dusts, granules, water-dispersible granules, microcapsules or wettable powders, or liquids, such as, for example, emulsifiable concentrates, solutions, emulsions or suspensions, ZC formulations. They can also be provided as a pre-mix or tank mixes.

In accordance with present invention the method of control of target weeds may be carried out by spraying the suggested tank mixes, or the individual herbicides may be formulated as a kit-of-parts containing various components that may be mixed as instructed prior to spraying.

In one preferred embodiment, the present invention provides a method of controlling weeds comprising applying or contacting herbicide combinations comprising a sulfonyl amino carbonyl triazolinone herbicide and a safener to seeds, foliage or at a locus of a crop, wherein said herbicide combinations exhibits minimal or no phytotoxicity.

Accordingly, the present invention provides a method of controlling weeds comprising applying or contacting herbicide combinations comprising a sulfonyl amino carbonyl triazolinone herbicide and a safener to seeds, foliage or at a locus of a crop, wherein the sulfonyl amino carbonyl triazolinone is Flucarbazone or Propoxycarbazone and the safener is selected from one or more of Cyprosulfamid, Mefenpyr, Mefenpyr-diethyl, Isoxadifen, Isoxadifen-ethyl, Cloquintocet-mexyl, Benoxacor, Flurazole and Fluxofenim, wherein said herbicide combinations exhibits minimal or no phytotoxicity.

The present invention provides a method of controlling weeds comprising applying herbicide combinations comprising a sulfonyl amino carbonyl triazolinone and a safener wherein the ratio of the sulfonyl amino carbonyl triazolinone herbicide to the safener is from 100:1 to 1:1 or 90:1 to 1:1, or 75:1 to 1:1 or 50:1 to 1:1 or 25:1 to 1.1 or 10:1 to 1:1 or 5:1 to 1:1 or 2:1 to 1:1, more preferably from 25:1 to 1.1 or 10:1 to 1:1 or 5:1 to 1:1 or 3:1 to 1:1 or 2:1 to 1.1, most preferably from 2:1 to 1:1.

Preferably, the ratio of a sulfonyl amino carbonyl triazolinone and a safener is 3:1 to 1:1, or 2:1 or 1.75:1, or 1.5:1 or 1:1, more preferably 1.75:1, or 1.5:1 or 1:1, most preferably 1.75:1. In one embodiment, the present invention provides a method of controlling weeds comprising applying or contacting herbicide combinations comprising a sulfonyl amino carbonyl triazolinone herbicide and a safener to seeds, foliage or at a locus of a crop, wherein the sulfonyl amino carbonyl triazolinone is Flucarbazone or Propoxycarbazone and the safener is Cyprosulfamid, wherein said herbicide combination exhibits minimal or no phytotoxicity.

In one embodiment, the present invention provides a method of controlling weeds comprising applying or contacting herbicide combinations comprising Flucarbazone and Cyprosulfamid to seeds, foliage or at a locus of a crop, wherein said herbicide combinations exhibits minimal or no phytotoxicity.

Accordingly, the ratio of Flucarbazone and Cyprosulfamid is 3:1 to 1:1, 2:1 or 1.75:1, or 1.5:1 or 1:1, more preferably 1.75:1, or 1.5:1 or 1:1, most preferably 1.75:1.

In one more embodiment, the present invention provides a method of controlling weeds comprising applying or contacting herbicide combinations comprising Propoxycarbazone and Cyprosulfamid to seeds, foliage or at a locus of a crop, wherein said herbicide combinations exhibits minimal or no phytotoxicity.

Accordingly, the ratio of Propoxycarbazone and Cyprosulfamid is 3:1 to 1:1, 2:1 or 1.75:1, or 1.5:1 or 1:1, more preferably 1.75:1, or 1.5:1 or 1:1, most preferably 1.75:1.

In an additional preferred embodiment, the present invention provides a method of controlling weeds, wherein an herbicide combination comprising Flucarbazone and Cyprosulfamid is applied to cereal crops, corn, wheat, barley, rye, oats, rice, soybean, cotton, canola, sugar beet, potatoes, tobacco, and oil seed rape, preferably to corn.

In an additional preferred embodiment, the present invention provides a method of controlling weeds, wherein Cyprosulfamid is applied to seeds of corn, wheat, barley, rye, oats, rice, soybean, cotton, canola, sugar beet, potatoes, tobacco, and oil seed rape, more preferably to seeds of corn, and Flucarbazone is applied later to the soil or to grown crops.

In still another embodiment, the present invention provides a method of controlling weeds wherein the combination of Flucarbazone and Cyprosulfamid is formulated together and applied in pre-emergence application or post-emergence application to foliage or at the locus of preferably corn, wheat, barley, rye, oats, rice, soybean, cotton, canola, sugar beet, potatoes, tobacco, and oil seed rape, more preferably to wheat, wherein Flucarbazone is applied at the rate from 20 to 100 g ai/ha, preferably 20 to 40 g ai/ha and Cyprosulfamid applied at the rate ranging from 50 to 70 g ai/ha, preferably at 60 or 70 g ai/ha.

In one preferred embodiment, the present invention provides a method of controlling weeds, wherein the combination of Flucarbazone and Cyprosulfamid is formulated together and applied in pre-emergence application or post-emergence application to foliage or at the locus of preferably corn, wheat, barley, rye, oats, rice, soybean, cotton, canola, sugar beet, potatoes, tobacco, and oil seed rape, more preferably to wheat, wherein Flucarbazone is applied at the rate of 30 g ai/ha and Cyprosulfamid applied at the rate of 66 g ai/ha.

In one more preferred embodiment, the present invention provides a method of controlling weeds, wherein the combination of Flucarbazone and Cyprosulfamid is formulated together and applied in pre-emergence application or post-emergence application preferably to foliage or at the locus of corn crop, wherein Flucarbazone is applied at the rate of 30 g ai/ha and Cyprosulfamid applied at the rate of 66 g ai/ha.

In still another embodiment, the present invention provides a method of controlling weeds, wherein Cyprosulfamid is applied to seeds of corn, wheat, barley, rye, oats, rice, soybean, cotton, canola, sugar beet, potatoes, tobacco, and oil seed rape, more preferably to seeds of corn, and Flucarbazone is applied later to the soil or grown crops, wherein Flucarbazone is applied at the rate from 20 to 40 g ai/ha and Cyprosulfamid applied at the rate ranging from 0.1 to 10 g. ai/Kg seed, preferably at 0.1 to 5 g. ai/Kg seed.

In still another embodiment, the present invention provides a method of controlling weeds, wherein Cyprosulfamid is applied to seeds of corn, wheat, barley, rye, oats, rice, soybean, cotton, canola, sugar beet, potatoes, tobacco, and oil seed rape, more preferably to seeds of corn, and Flucarbazone is applied later to the soil or grown crops, wherein Flucarbazone is applied at the rate of 30 g ai/ha and Cyprosulfamid applied at the rate of 0.2 g. ai/Kg seed

In an embodiment, the present invention provides a method of controlling weeds, wherein an herbicide combination comprising Propoxycarbazone and Cyprosulfamid is applied to cereal crops, corn, wheat, barley, rye, oats, rice, soybean, cotton, canola, sugar beet, potatoes, tobacco, and oil seed rape, preferably to corn.

In an additional preferred embodiment, the present invention provides a method of controlling weeds, wherein Cyprosulfamid is applied to seeds of corn, wheat, barley, rye, oats, rice, soybean, cotton, canola, sugar beet, potatoes, tobacco, and oil seed rape, more preferably to seeds of corn, and Propoxycarbazone is applied later to the soil or to grown crops.

In still another embodiment, the present invention provides a method of controlling weeds wherein the combination of Propoxycarbazone and Cyprosulfamid is formulated together and applied in pre-emergence application or post-emergence application to foliage or at the locus of preferably corn, wheat, barley, rye, oats, rice, soybean, cotton, canola, sugar beet, potatoes, tobacco, and oil seed rape, more preferably to wheat, wherein Propoxycarbazone is applied at the rate from 20 to 100 g ai/ha or 20 to 40 g ai/ha and Cyprosulfamid applied at the rate ranging from 50 to 70 g ai/ha, preferably at 60 or 70 g ai/ha.

In one preferred embodiment, the present invention provides a method of controlling weeds, wherein the combination of Propoxycarbazone and Cyprosulfamid is formulated together and applied in pre-emergence application or post-emergence application to foliage or at the locus of preferably corn, wheat, barley, rye, oats, rice, soybean, cotton, canola, sugar beet, potatoes, tobacco, and oil seed rape, more preferably to wheat, wherein Propoxycarbazone is applied at the rate of 30 g ai/ha and Cyprosulfamid applied at the rate of 66 g ai/ha.

In one more preferred embodiment, the present invention provides a method of controlling weeds, wherein the combination of Propoxycarbazone and Cyprosulfamid is formulated together and applied in pre-emergence application or post-emergence application preferably to foliage or at the locus of corn crop, wherein Propoxycarbazone is applied at the rate of 30 g ai/ha and Cyprosulfamid applied at the rate of 66 g ai/ha.

In still another embodiment, the present invention provides a method of controlling weeds, wherein Cyprosulfamid is applied to seeds of corn, wheat, barley, rye, oats, rice, soybean, cotton, canola, sugar beet, potatoes, tobacco, and oil seed rape, more preferably to seeds of corn, and Propoxycarbazone is applied later to the soil or grown crops, wherein Propoxycarbazone is applied at the rate from 20 to 40 g ai/ha and Cyprosulfamid applied at the rate ranging from 0.1 to 10 g. ai/Kg seed, preferably at 0.1 to 5 g. ai/Kg seed.

In still another embodiment, the present invention provides a method of controlling weeds, wherein Cyprosulfamid is applied to seeds of corn, wheat, barley, rye, oats, rice, soybean, cotton, canola, sugar beet, potatoes, tobacco, and oil seed rape, more preferably to seeds of corn, and Propoxycarbazone is applied later to the soil or grown crops, wherein Propoxycarbazone is applied at the rate of 30 g ai/ha and Cyprosulfamid applied at the rate of 0.2 g. ai/Kg seed

The present invention provides a method of reducing phytotoxicity in cereal crops comprising applying or contacting herbicide combinations comprising a sulfonyl amino carbonyl triazolinone herbicide and a safener to seeds, foliage or at a locus of a crop, wherein the sulfonyl amino carbonyl triazolinone is Flucarbazone or Propoxycarbazone and the safener is selected from one or more of Cyprosulfamid, Mefenpyr, Mefenpyr-diethyl, Isoxadifen, Isoxadifen-ethyl, Cloquintocet-mexyl, Benoxacor, Flurazole and Fluxofenim, wherein said herbicide combination exhibits minimal or no phytotoxicity.

In a further preferred embodiment, the present invention provides a method of reducing phytotoxicity in cereal crops wherein an herbicide combination comprising Flucarbazone and Cyprosulfamid is applied preferably to cereal crops, corn, wheat, barley, rye, oats, rice, soybean, cotton, canola, sugar beet, potatoes, tobacco, and oil seed rape, more preferably to corn.

In still another embodiment, the present invention provides a method of reducing phytotoxicity in cereal crops wherein the combination of Flucarbazone and Cyprosulfamid is formulated together and applied in pre-emergence application or post-emergence application to foliage or at the locus of preferably corn, wheat, barley, rye, oats, rice, soybean, cotton, canola, sugar beet, potatoes, tobacco, and oil seed rape, more preferably to wheat, wherein Flucarbazone is applied at the rate from 20 to 100 g ai/ha and Cyprosulfamid applied at the rate ranging from 50 to 250 g ai/ha, preferably at 50 or 150 g ai/ha.

In still another embodiment, the present invention provides a method of reducing phytotoxicity in cereal crops wherein the combination of Flucarbazone and Cyprosulfamid is formulated together and applied in pre-emergence application or post-emergence application to foliage or at the locus of preferably corn, wheat, barley, rye, oats, rice, soybean, cotton, canola, sugar beet, potatoes, tobacco, and oil seed rape, more preferably to wheat, wherein Flucarbazone is applied at the rate from 20 to 40 g ai/ha and Cyprosulfamid applied at the rate ranging from 50 to 70 g ai/ha, preferably at 60 or 70 g ai/ha.

In one preferred embodiment, the present invention provides a method of reducing phytotoxicity in cereal crops, wherein the combination of Flucarbazone and Cyprosulfamid is formulated together and applied in pre-emergence application or post-emergence application to foliage or at the locus of preferably corn, wheat, barley, rye, oats, rice, soybean, cotton, canola, sugar beet, potatoes, tobacco, and oil seed rape, more preferably to wheat, wherein Flucarbazone is applied at the rate of 30 g ai/ha and Cyprosulfamid applied at the rate of 66 g ai/ha.

In one more preferred embodiment, the present invention provides a method of reducing phytotoxicity in cereal crops, wherein the combination of Flucarbazone and Cyprosulfamid is formulated together and applied in pre-emergence application or post-emergence application preferably to foliage or at the locus of corn crop, wherein Flucarbazone is applied at the rate of 30 g ai/ha and Cyprosulfamid applied at the rate of 66 g ai/ha.

In a further preferred embodiment, the present invention provides a method of reducing phytotoxicity in cereal crops, wherein Cyprosulfamid is applied to seeds of corn, wheat, barley, rye, oats, rice, soybean, cotton, canola, sugar beet, potatoes, tobacco, and oil seed rape, more preferably to seeds of corn, and Flucarbazone is applied later to the soil or to grown crops.

In still another embodiment, the present invention provides method of reducing phytotoxicity in cereal crops, wherein Cyprosulfamid is applied to seeds of corn, wheat, barley, rye, oats, rice, soybean, cotton, canola, sugar beet, potatoes, tobacco, and oil seed rape, more preferably to seeds of corn, and Flucarbazone is applied later to the soil or grown crops, wherein Flucarbazone is applied at the rate from 20 to 40 g ai/ha and Cyprosulfamid applied at the rate ranging from 0.1 to 10 g. ai/Kg seed, preferably at 0.1 to 5 g. ai/Kg seed.

In still another embodiment, the present invention provides a method of reducing phytotoxicity in cereal crops, wherein Cyprosulfamid is applied to seeds of corn, wheat, barley, rye, oats, rice, soybean, cotton, canola, sugar beet, potatoes, tobacco, and oil seed rape, more preferably to seeds of corn, and Flucarbazone is applied later to the soil or grown crops, wherein Flucarbazone is applied at the rate of 30 g ai/ha and Cyprosulfamid applied at the rate of 0.2 g. ai/Kg seed.

In a further preferred embodiment, the present invention provides a method of reducing phytotoxicity in cereal crops wherein an herbicide combination comprising Propoxycarbazone and Cyprosulfamid is applied preferably to cereal crops, corn, wheat, barley, rye, oats, rice, soybean, cotton, canola, sugar beet, potatoes, tobacco, and oil seed rape, more preferably to corn.

In another embodiment, the present invention provides a method of reducing phytotoxicity in cereal crops wherein the combination of Propoxycarbazone and Cyprosulfamid is formulated together and applied in pre-emergence application or post-emergence application to foliage or at the locus of preferably corn, wheat, barley, rye, oats, rice, soybean, cotton, canola, sugar beet, potatoes, tobacco, and oil seed rape, more preferably to wheat, wherein Propoxycarbazone is applied at the rate from 20 to 40 g ai/ha and Cyprosulfamid applied at the rate ranging from 50 to 250 g ai/ha, preferably at 50 or 150 g ai/ha.

In still another embodiment, the present invention provides a method of reducing phytotoxicity in cereal crops wherein the combination of Propoxycarbazone and Cyprosulfamid is formulated together and applied in pre-emergence application or post-emergence application to foliage or at the locus of preferably corn, wheat, barley, rye, oats, rice, soybean, cotton, canola, sugar beet, potatoes, tobacco, and oil seed rape, more preferably to wheat, wherein Propoxycarbazone is applied at the rate from 20 to 40 g ai/ha and Cyprosulfamid applied at the rate ranging from 50 to 70 g ai/ha, preferably at 60 or 70 g ai/ha.

In one preferred embodiment, the present invention provides a method of reducing phytotoxicity in cereal crops, wherein the combination of Propoxycarbazone and Cyprosulfamid is formulated together and applied in pre-emergence application or post-emergence application to foliage or at the locus of preferably corn, wheat, barley, rye, oats, rice, soybean, cotton, canola, sugar beet, potatoes, tobacco, and oil seed rape, more preferably to wheat, wherein Propoxycarbazone is applied at the rate of 30 g ai/ha and Cyprosulfamid applied at the rate of 66 g ai/ha.

In one more preferred embodiment, the present invention provides a method of reducing phytotoxicity in cereal crops, wherein the combination of Propoxycarbazone and Cyprosulfamid is formulated together and applied in pre-emergence application or post-emergence application preferably to foliage or at the locus of corn crop, wherein Propoxycarbazone is applied at the rate of 30 g ai/ha and Cyprosulfamid applied at the rate of 66 g ai/ha.

In a further preferred embodiment, the present invention provides a method of reducing phytotoxicity in cereal crops, wherein Cyprosulfamid is applied to seeds of corn, wheat, barley, rye, oats, rice, soybean, cotton, canola, sugar beet, potatoes, tobacco, and oil seed rape, more preferably to seeds of corn, and Propoxycarbazone is applied later to the soil or to grown crops.

In still another embodiment, the present invention provides method of reducing phytotoxicity in cereal crops, wherein Cyprosulfamid is applied to seeds of corn, wheat, barley, rye, oats, rice, soybean, cotton, canola, sugar beet, potatoes, tobacco, and oil seed rape, more preferably to seeds of corn, and Propoxycarbazone is applied later to the soil or grown crops, wherein Propoxycarbazone is applied at the rate from 20 to 40 g ai/ha and Cyprosulfamid applied at the rate ranging from 0.1 to 10 g. ai/Kg seed, preferably at 0.1 to 5 g. ai/Kg seed.

In still another embodiment, the present invention provides a method of reducing phytotoxicity in cereal crops, wherein Cyprosulfamid is applied to seeds of corn, wheat, barley, rye, oats, rice, soybean, cotton, canola, sugar beet, potatoes, tobacco, and oil seed rape, more preferably to seeds of corn, and Propoxycarbazone is applied later to the soil or grown crops, wherein Propoxycarbazone applied at the rate of 30 g ai/ha and Cyprosulfamid applied at the rate of 0.2 g. ai/Kg seed.

The herbicide safener compositions of the present invention can reduce phytotoxicity of Triazolinone herbicides and therefore provide selective control of weeds in crop plants, preferably in corn.

In an embodiment, the present invention provides for the use of the herbicide combinations comprising one or more Triazolinone herbicides and one or more safeners for effective control of weeds and reduced phytotoxicity in crops.

In one embodiment, the present invention provides for the use of the herbicide combinations comprising one or more Triazolinone herbicides and one or more safeners for effective control of weeds and reduced phytotoxicity in crops, wherein said triazolinone herbicides are selected from Flucarbazone, Propoxycarbazone, Carfentrazone, Sulfentrazone and Amicarbazone or combinations thereof.

In an embodiment, the present invention provides use of the herbicide safener compositions comprising one or more of triazolinone herbicides and one or more safeners selected from one or more of Cyprosulfamid, Mefenpyr, Mefenpyr-diethyl, Isoxadifen, Isoxadifen-ethyl, Cloquintocet-mexyl, Benoxacor, Flurazole and Fluxofenim, preferably Cyprosulfamid for effective control of weeds and reduced phytotoxicity in crops, for an increase in plant height and/or increased number of crop plants standing after treatment, preferably in cereal crops, corn, wheat, barley, rye, oats, rice, soybean, cotton, canola, sugar beet, potatoes, tobacco, and oil seed rape, more preferably in corn.

Accordingly, the present invention provides for the use of herbicide combinations comprising a triazolinone herbicide and a safener, for effective control of weeds and reduced phytotoxicity in crops, for an increase in plant height and/or increased number of crop plants standing after treatment, preferably in cereal crops, corn, wheat, barley, rye, oats, rice, soybean, cotton, canola, sugar beet, potatoes, tobacco, and oil seed rape, more preferably in corn. wherein the ratio of the sulfonyl amino carbonyl triazolinone herbicide to the safener is from 100:1 to 1:1 or 90:1 to 1:1, or 75:1 to 1:1 or 50:1 to 1:1 or 25:1 to 1.1 or 10:1 to 1:1 or 5:1 to 1:1 or 2:1 to 1:1, more preferably from 25:1 to 1.1 or 10:1 to 1:1 or 5:1 to 1:1 or 2:1 to 1.1, most preferably from 2:1 to 1:1.

In one preferred embodiment, the present invention provides for the use of herbicide combinations comprising one or more sulfonyl amino carbonyl triazolinone herbicides and one or more safeners for effective control of weeds and reduced phytotoxicity in crops, for an increase in plant height and/or increased number of crop plants standing after treatment, preferably in cereal crops, corn, wheat, barley, rye, oats, rice, soybean, cotton, canola, sugar beet, potatoes, tobacco, and oil seed rape, wherein the sulfonyl amino carbonyl triazolinone herbicides are selected from Flucarbazone and/or Propoxycarbazone, and wherein the safener is Cyprosulfamid.

In one further preferred embodiment, the present invention provides for the use of herbicide combinations comprising Flucarbazone and Cyprosulfamid for the effective control of weeds and for reduced phytotoxicity in crops.

In one further preferred embodiment, the present invention provides for the use of herbicide combinations comprising Flucarbazone and Cyprosulfamid for the effective control of weeds and for reducing phytotoxicity in corn crops.

In one further preferred embodiment, the present invention provides for the use of herbicide combinations comprising Flucarbazone and Isoxadifen for the effective control of weeds and for reduced phytotoxicity in crops.

In one further preferred embodiment, the present invention provides for the use of herbicide combinations comprising Flucarbazone and Isoxadifen ethyl for the effective control of weeds and for reduced phytotoxicity in crops.

In one further embodiment, the present invention provides for the use of herbicide combinations comprising Propoxycarbazone and Cyprosulfamid for the effective control of weeds and for reduced phytotoxicity in crops.

In one further preferred embodiment, the present invention provides for the use of herbicide combinations comprising Propoxycarbazone and Isoxadifen for the effective control of weeds and for reduced phytotoxicity in crops.

In one further preferred embodiment, the present invention provides for the use of herbicide combinations comprising Propoxycarbazone and Isoxadifen ethyl for the effective control of weeds and for reduced phytotoxicity in crops.

As will be demonstrated in the examples, the combinations of one or more Triazolinone herbicides, preferably Flucarbazone herbicide, and one or more safeners, preferably cyprosulfamid, significantly reduced phytotoxicity of herbicides over an extended interval of time, which has resulted in increased height of plants and/or increased number of plants standing after treatments.

These and other advantages of the invention may become more apparent from the examples set forth herein below. These examples are provided merely as illustrations of the invention and are not intended to be construed as a limitation thereof.

The present invention therefore provides a method of controlling weeds thereby providing resistance management and synergistic control of the weeds. The present invention also provides an adequate method to achieve complete control of weeds, improving yields, while targeting resistance management.

The invention will now be described in more details with reference to the following examples. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and following examples, but by all embodiments and methods within the scope and spirit of the invention.

### EXAMPLES

### Example 1

Treatment: The present invention has employed a tank mix combination of Flucarbazone and Cyprosulfamid as the safener to evaluate its percentage phytotoxicity and its efficacy in the control of weeds. Additionally, to prove the synergy of the present herbicide combination of Flucarbazone and Cyprosulfamid, the present inventors have also used a Flucarbazone formulation individually in the form of wet dispersible granules to estimate its percentage phytotoxicity and the percentage efficacy control of weeds.

TABLE 1

| | Form. | Form. | |
|---|---|---|---|
| Treatment Name | Conc. | Type | Rate |
| Flucarbazone | 700 gA/kg | WDG | 30 g ai/ha |
| Flucarbazone | 700 | WDG | 30 g ai/ha |
| Cyprosulfamid | 400 | WP | 66 g ai/ha |

WDG: Water dispersible granules
WP: Wettable powder

### Example 2: Evaluation of % Phytotoxicity for Application of Flucarbazone and Cyprosulfamid

The tank mix combination of Flucarbazone and Cyprosulfamid as the safener was formulated and the combination was sprayed onto corn crop and the results on the phytotoxicity in corn were determined. These observations relating to % phytotoxicity were made during a time interval of over a month. The duration at which the % phytotoxicity were determined at time intervals as follows: 3 DAA (3 days after application), 5 DAA (5 days after application), 7 DAA (7 days after application), 14 DAA (14 days after application), 21 DAA (21 days after application); 28 DAA (28 days after application); 35 DAA (35 days after application); 42DAA (42 days after application).

Accordingly, the % phytotoxicity in corn crop was observed to be considerably reduced over a period of one month after application of herbicide combination, when the tank mix combination of Flucarbazone and Cyprosulfamid was employed. This % phytotoxicity was observed by the present inventors to be sustained at negligible levels up to 42DAA, with good crop yield and quality. On the other hand, the corn crop treated with Flucarbazone individually suffered significant damage over the time interval of one month, with % phytotoxicity levels reaching up to 50% at 14 DAA, with such % phytotoxicity levels being maintained even after 28DAA.

TABLE 2
Phytotoxicity (%) in corn crop using for Flucarbazone and Cyprosulfamid

| Treatment Name | 3DAA & 5DAA | | | 7DAA | | | 14 DAA | | | 21DAA | | |
|---|---|---|---|---|---|---|---|---|---|---|---|---|
| flucarbazone | 0 | 0 | 0 | 28.8 | 28.8 | 28.8 | 51.3 | 53.8 | 50 | 50 | 51.3 | 46.3 |
| flucarbazone cyprosulfamid | 0 | 0 | 0 | 3.8 | 6.3 | 3.8 | 15 | 15 | 12.5 | 10 | 10 | 10 |

| Treatment Name | 28DAA | | | 35DAA | | | 42DAA | | |
|---|---|---|---|---|---|---|---|---|---|
| flucarbazone | 47.5 | 56.3 | 39.8 | 44.9 | 53.8 | 39.9 | 42.4 | 48.7 | 38.7 |
| flucarbazone cyprosulfamid | 0.6 | 5 | 1.3 | 0 | 0 | 0 | 0 | 0 | 0 |

### Example 3: Efficacy % of Flucarbazone and Cyprosulfamid Tank Mix Against Redroot Pigweed

The tank mix combination of Flucarbazone and Cyprosulfamid as the safener was formulated and the combination was sprayed onto corn crop and the results on the efficacy in weed control were determined.

TABLE 3
% Efficacy for control of weeds

| Treatment Name | 7 DAA | 14 DAA | 21 DAA | 28 DAA | 35 DAA | 42 DAA |
|---|---|---|---|---|---|---|
| flucarbazone | 22.5 | 42.5 | 45 | 48.8 | 48.8 | 48.8 |
| flucarbazone | 17.5 | 66.3 | 63.8 | 70 | 68.8 | 60.0 |
| cyprosulfamid | | | | | | |

Accordingly, % efficacy in control of redroot pigweed in corn crop was observed to be considerably sustained over a period of one month, when the tank mix of Flucarbazone and Cyprosulfamid was employed. This % efficacy control of the redroot pigweed was observed by the present inventors to be sustained in the range of 60% to 70% over a duration of one month. On the other hand, the corn crop treated with Flucarbazone was observed to have a reduced % efficacy compared to the Flucarbazone and cyprosulfamid tank mix.

### Example 4: Comparative Observations of Use of Other Safeners with Flucarbazone

A) Flucarbazone with Isoxadifen as the Safener

TABLE 4

| | Form. | Form | |
|---|---|---|---|
| Treatment Name | Conc. | Type | Rate |
| flucarbazone | 700 gA/kg | WDG | 30 g ai/ha |
| flucarbazone | 700 | WDG | 30 g ai/ha |
| Isoxadifen | 500 | WP | 38 g ai/ha |

(i) Treatment: The present invention has employed a tank mix of Flucarbazone and Isoxadifen as the safener to evaluate its percentage phytotoxicity in corn crop.
(ii) % Phytotoxicity: This % phytotoxicity was observed by the present inventors to be as high as 48% at 14 DAA in crops treated with Flucarbazone and Isoxadifen.

TABLE 5
Phytotoxicity (%) in corn crop using for Flucarbazone and Isoxadifen

| Treatment | 3DAA & 5DAA | | | 7DAA | | | 14 DAA | | | 21DAA | | |
|---|---|---|---|---|---|---|---|---|---|---|---|---|
| flucarbazone | 0 | 0 | 0 | 28.8 | 28.8 | 28.8 | 51.3 | 53.8 | 50 | 50 | 51.3 | 46.3 |
| Flucarbazone Isoxadifen | 0 | 0 | 0 | 33.8 | 32.5 | 32.5 | 21.3 | 48.8 | 40 | 16.3 | 36.3 | 37.5 |

| Treatment | 28DAA | | | 35DAA | | | 42DAA | | |
|---|---|---|---|---|---|---|---|---|---|
| flucarbazone | 47.5 | 56.3 | 39.8 | 44.9 | 53.8 | 39.9 | 42.4 | 48.7 | 38.7 |
| Flucarbazone Isoxadifen | 1.3 | 23.8 | 8.9 | 0.6 | 8.9 | 7.4 | 0.6 | 7.4 | 7.4 |

B) Flucarbazone with Mefenpyr as the Safener
(i) Treatment: The present invention has employed a tank mix combination of Flucarbazone and isoxadifen as the safener to evaluate its percentage phytotoxicity in corn crop.

TABLE 6

| | Form. | Form | |
|---|---|---|---|
| Treatment Name | Conc. | Type | Rate |
| flucarbazone | 700 gA/kg | WDG | 30 g ai/ha |
| flucarbazone | 700 | WDG | 30 g ai/ha |
| mefenpyr | 400 | WP | 30 g ai/ha |

(ii) % Phytotoxicity

TABLE 7
Phytotoxicity (%) in corn crop using Flucarbazone and Mefenpyr

| | Treatment Name | | | | | | | | | | | |
|---|---|---|---|---|---|---|---|---|---|---|---|---|
| | 3DAA & | | | | | | | | | | | |
| | 5DAA | | | 7DAA | | | 14 DAA | | | 21DAA | | |
| flucarbazone | 0 | 0 | 0 | 28.8 | 28.8 | 28.8 | 51.3 | 53.8 | 50 | 50 | 51.3 | 46.3 |
| flucarbazone | 0 | 0 | 0 | 22.5 | 33.8 | 28.8 | 56.3 | 56.3 | 55 | 56.3 | 57.5 | 53.8 |
| mefenpyr | | | | | | | | | | | | |

| | Treatment Name | | | | | | | | |
|---|---|---|---|---|---|---|---|---|---|
| | 28DAA | | | 35DAA | | | 42DAA | | |
| flucarbazone | 47.5 | 56.3 | 39.8 | 44.9 | 53.8 | 39.9 | 42.4 | 48.7 | 38.7 |
| flucarbazone | 62.6 | 60 | 55.2 | 61.3 | 60.1 | 55.1 | 56.3 | 55.1 | 50 |
| mefenpyr | | | | | | | | | |

Accordingly, the % phytotoxicity in corn crop was observed to be significantly high over a period of one month, when the tank mix combination of Flucarbazone and Mefenpyr was employed.

This % phytotoxicity was observed by the present inventors to be as high as 56% at 14 DAA in crops treated with Flucarbazone and Mefenpyr. Further, phytotoxicity was observed even at 21 DAA and 28DAA. The highest phytotoxicity was observed at 35 DAA, with levels reaching as high as 60%. It is also vital to note here that phytotoxicity levels in corn crop, when Flucarbazone is used individually was almost at par and/or were reduced compared to the phytotoxicity levels of the combination of Flucarbazone and Mefenpyr.

Therefore, it was concluded that the phytotoxicity reduction in flucarbazone due to being combined with either cyprosulfamid or isoxadifen or both were surprisingly better and selective than that observed with mefenpyr.

### Example 5: Evaluation of Selectivity of Flucarbazone with Safeners

The combination of flucarbazone with safeners selected from cyprosulfamid and isoxadifen were evaluated in terms of the increase or decrease in height of the treated corn crop (cm) and % phytotoxicity. The experimental evaluations were conducted under greenhouse conditions with 4 repetitions, using a spray volume of 150 L/ha. The different corn varieties tested were SYN8A98 TLTG and XB 8010.

### A. Determining Height of the Corn Plant on Treatment

The observations for determining corn height were made at 14 DAA (days after application) of the herbicide. The treatment employed and the corresponding observations are detailed in the table 8 (i) & (ii) below:

TABLE 8 (i)

| Treatment | | Form. Conc. | Form | |
|---|---|---|---|---|
| No. | Treatment Name | g/kg | Type | Rate |
| 1. | Untreated | — | — | — |
| 2. | flucarbazone | 700 | WDG | 30 g ai/ha |
| 3. | flucarbazone | 700 | WDG | 30 g ai/ha |
| | Cyprosulfamid | 400 | WP | 90 g ai/ha |
| 4. | flucarbazone | 700 | WDG | 30 g ai/ha |
| | Isoxadifen | 500 | WP | 90 g ai/ha |

TABLE 8 (ii)

| | | Crop height (cm) at 14 DAA | | | |
|---|---|---|---|---|---|
| Treatment Name | Rate | SYN8A98 TLTG | | XB 8010 | |
| Untreated | — | 15 | ab | 15 | abc |
| flucarbazone | 30 g ai/ha | 14 | abc | 11 | def |
| flucarbazone | 30 g ai/ha | 15 | abc | 16 | a |
| Cyprosulfamid | 90 g ai/ha | | | | |
| flucarbazone | 30 g ai/ha | 12 | bcd | 11 | c-f |
| Isoxadifen | 90 g ai/ha | | | | |

The small letter indicates significant differences by Duncan test (p ≤ 0.05) between the treatments.

The height of the corn plants treated with the herbicide combination of flucarbazone and cyprosulfamid showed an excellent increase in height which was similar to the untreated corn crop. However, corn plants treated with flucarbazone individually showed reduction in height, further corn plants treated with the herbicide combination of flucarbazone and isoxadifen as the safener showed a further reduction in height.

### B. Determining % Phytotoxicity of the Treatment

The observations for determining corn height were made at 7 DAA (days after application), 14 DAA and 21 DAA, of the herbicide. The treatment employed and the corresponding observations are detailed in the table 9 (i) & (ii) below:

TABLE 9 (i)

| Treatment | | Form. Conc. | Form | Rate |
|---|---|---|---|---|
| No. | Treatment Name | g/kg | Type | g ai/ha |
| 1. | Untreated | — | — | — |
| 2. | flucarbazone | 700 | WDG | 45 |
| 3. | flucarbazone | 700 | WDG | 45 |
| | cyprosulfamid | 400 | WP | 90 |
| 4. | flucarbazone | 700 | WDG | 45 |
| | cyprosulfamid | 400 | WP | 148.5 |
| 5. | flucarbazone | 700 | WDG | 45 |
| | isoxadifen | 500 | WP | 90 |
| 6. | flucarbazone | 700 | WDG | 45 |
| | isoxadifen | 500 | WP | 148.5 |

TABLE 9 (ii)

| | | | % phytotoxocity of corn | | |
|---|---|---|---|---|---|
| Treatment | | Rate | crop variety SYN8A98 TLTG | | |
| No. | Treatment Name | g ai/ha | 7DAA | 14 DAA | 21 DAA |
| 1. | Untreated | — | 0 | 0 | 0 |
| 2. | flucarbazone | 45 | 19 cd | 47 ab | 48 bc |
| 3. | flucarbazone | 45 | 16 de | 7 de | 5 ef |
| | Cyprosulfamid | 90 | | | |
| 4. | flucarbazone | 45 | 13 ef | 3 ef | 3 ef |
| | Cyprosulfamid | 148.5 | | | |
| 5. | flucarbazone | 45 | 25 ab | 43 bc | 41 cd |
| | Isoxadifen | 90 | | | |
| 6. | flucarbazone | 45 | 21 bcd | 51 a | 59 a |
| | Isoxadifen | 148.5 | | | |

The small letter indicates significant differences by Duncan test (p ≤ 0.05) between the treatments.

TABLE 9 (iii)

| | | | % phytotoxocity of corn | | |
|---|---|---|---|---|---|
| Treatment | Treatment | Rate | crop variety P4285VYHR | | |
| No. | Name | g ai/ha | 7DAA | 14 DAA | 21 DAA |
| 1. | Untreated | — | 0 | 0 | 0 |
| 2. | flucarbazone | 45 | 26 ab | 34 b | 32 b |
| 3. | flucarbazone | 45 | 15 d | 5 fg | 5 de |
| | Cyprosulfamid | 90 | | | |
| 4. | flucarbazone | 45 | 16 d | 3 fg | 2 de |
| | Cyprosulfamid | 148.5 | | | |
| 5. | flucarbazone | 45 | 25 abc | 14 de | 11 cd |
| | Isoxadifen | 90 | | | |
| 6. | flucarbazone | 45 | 27 a | 17 cd | 16 c |
| | Isoxadifen | 148.5 | | | |

The small letter indicates significant differences by Duncan test (p ≤ 0.05) between the treatments.

TABLE 9 (iv)

| | | | % phytotoxocity of corn | | |
|---|---|---|---|---|---|
| Treatment | | Rate | crop variety XB 8010 | | |
| No. | Treatment Name | g ai/ha | 7DAA | 14 DAA | 21 DAA |
| 1. | Untreated | — | 0 | 0 | 0 |
| 2. | flucarbazone | 45 | 28 a | 52 ab | 51 ab |
| 3. | flucarbazone | 45 | 20 cde | 4 def | 5 e |
| | Cyprosulfamid | 90 | | | |
| 4. | flucarbazone | 45 | 23 bcd | 3 ef | 2 e |
| | Cyprosulfamid | 148.5 | | | |
| 5. | flucarbazone | 45 | 26 ab | 44 bc | 47 bc |
| | Isoxadifen | 90 | | | |
| 6. | flucarbazone | 45 | 25 abc | 49 abc | 48 bc |
| | Isoxadifen | 148.5 | | | |

The small letter indicates significant differences by Duncan test (p ≤0.05) between the treatments.

The % phytotoxicity on corn plants treated with the herbicide combination of flucarbazone and cyprosulfamid showed considerable reduction compared to flucarbazone applied individually and in the treatment including flucarbazone and isoxadifen. Therefore, the present inventors have successfully showed that the combination of flucarbazone and cyprosulfamid effectively reduced phytotoxicity in corn crop over herbicide combinations consisting of other safeners.

We claim:

1. A method of reducing phytotoxicity in crops comprising applying an herbicide combination comprising a triazolinone herbicide and a safener to seeds, foliage or at a locus of a crop to inhibit growth of weeds, wherein the safener is cyprosulfamid.

2. The method as claimed in claim 1, wherein the ratio of the triazolinone herbicide and cyprosulfamid is ranging from 5:1 to 1:1.

3. The method as claimed in claim 1, wherein the triazolinone herbicide is selected from the group comprising Flucarbazone, Propoxycarbazone, Carfentrazone, Sulfentrazone and Amicarbazone

4. The method as claimed in claim 3, wherein the triazolinone herbicide is Flucarbazone.

5. The method as claimed in claim 1, wherein the weeds are selected from the group comprising Amaranthus spp., Amaranthus viridis, Cenchrus echinatus, broadleaf signal grass (Brachiaria platvphvlla), large crabgrass (Digitaria sanguinalis), barnyardgrass (Echinochloa crusgaili), rigid ryegrass (Lolium rigidum), fall panicum (Panicum dichotomiflorum), giant foxtail (Setaria faberi), green foxtail (Setaria viridis), Johnson grass (Sorghum halepense), velvetleaf (Abutilon theophrasti), redroot pigweed (Amaranthus retroflexus), common lambsquarters (Chenopodium album), Ivyleaf morning glory (Ipomoea hederacea), common purslane {Portulaca oleracea), and common cockleburr (Xanthium strumarium).

6. The method as claimed in claim 1, wherein the crop is selected from the group comprising cereal crops, preferably corn, wheat, barley, rye, oats and rice.

7. The method as claimed in claim 6, wherein the crop is corn crop.

8. The method as claimed in claim 1, wherein the triazolinone herbicide is applied at a rate ranging from 20 to 100 g ai/ha and the safener is applied at a rate ranging from 50 to 200 g ai/ha.

9. A method of reducing phytotoxicity in crops comprising applying an herbicide combination comprising a triazolinone herbicide and a safener to seeds, foliage or at a locus of a crop; wherein the safener is cyprosulfamid and wherein the ratio of the triazolinone herbicide and cyprosulfamid is ranging from 5:1 to 1:1.

10. The method as claimed in claim 9, comprising applying an herbicide combination comprising Flucarbazone and cyprosulfamid to seeds, foliage or at a locus of a crop; wherein the ratio of Flucarbazone and cyprosulfamid is ranging from 5:1 to 1:1.

11. The method as claimed in claim 10, wherein flucarbazone is applied at a rate ranging from 20 to 100 g ai/ha and cyprosulfamid is applied at a rate ranging from 50 to 200 g ai/ha.

12. An herbicide combination comprising a triazolinone herbicide and a safener, wherein the safener is cyprosulfamid.

13. The herbicide combination as claimed in claim 12, wherein the triazolinone herbicide is selected from the group comprising Flucarbazone, Propoxycarbazone, Carfentrazone, Sulfentrazone and Amicarbazone

14. The herbicide combination as claimed in claim 12, comprising flucarbazone and cyprosulfamid.

15. The herbicide combination as claimed in claim 12, wherein the ratio of flucarbazone and cyprosulfamid is ranging from 5:1 to 1:1.

16. The herbicide combination as claimed in claim 12, wherein flucarbazone is applied at a rate ranging from 20 to 100 g ai/ha and cyprosulfamid is applied at a rate ranging from 50 to 200 g ai/ha.
